(19) United States
(12) Patent Application Publication
(10) Pub. No.: US 2014/0288868 A1
(43) Pub. Date: Sep. 25, 2014

(54) Process for Monitoring Items that are Stored or in Transit

(71) Applicant: Robert Stetson Gorham, JR., Champaign, IL (US)

(72) Inventor: Robert Stetson Gorham, JR., Champaign, IL (US)

(21) Appl. No.: 13/847,133

(22) Filed: Mar. 19, 2013

(51) Int. Cl. G06Q 10/08

(52) U.S. Cl. CPC G06Q 10/0833
USPC 702/99; 235/376; 702/188

(57) ABSTRACT

This system can capture information about conditions or events that may have impacted goods which had been stored for shipment or warehousing. This may include time-of-departure, geo-position, in-transit temperature ranges and time the shipment may have been maintained outside required temperature levels. Information may also include motion or acceleration data which may correlate to driving incidents or mishaps. This information is harvested from sensors that are fixed inside the storage crates or shipping cases, captured wirelessly, analyzed and reported out through the internet to a secure server. Additional time and date stamped data is obtained from warehouse attendants, drivers or receiving personnel who can file photographic evidence of signed receipts, damaged goods or crushed crates to the same secure servers. This information can be made available before the goods are received. This data could suggest a particular shipment should be closely inspected. The invention also describes a means of on-site calibration of temperature sensors. The process re-sets monitoring and polling devices for new shipments or storage tasks using Bluetooth radio, Quick Response—QR codes and Near Field Communication NFC pairing protocols.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Technical Field

This invention relates to the World Wide Web, and more particularly, to a method and system for obtaining, organizing, storing and retrieving information that details conditions which have impacted items or materials during shipment or storage.

2. Problem Definition

Certain materials or devices may require specific storage temperature boundaries within which they may be safely stored or transported. Such items may include freeze sensitive chemicals, equipment, pharmaceuticals and foodstuffs. They may also include materials which must be kept below specific temperatures.

Often temperature sensitive materials may be sealed in containers which are difficult to access. These containers may be remotely located or they may be actually moving under transport.

While it may be assumed that such materials were placed in storage or transportation containers while in “good” or marketable condition, it is possible that over time, conditions had changed and the products or materials no longer are in that initial level of quality. Storage or transportation conditions may have over-heated or sub-cooled the products in question.

This program builds on several new technologies, such as “smart phones” are the ever expanding use of the Internet, distributed web based digital photography, secure server storage, and multi-sources geo-positioning data. The program has focused on fixed-mounted Bluetooth enabled sensing devices, wireless polling devices, Near Field Communication NFC pairing strategies, embedded QR coding and Non-contact temperature calibration.

The objective of this invention was to create a methodology which encourages effective monitoring of products which are being stored or transported. It also proposes a method for documenting events such as the transfer of custody by capturing signatures; it also proposes a method of documenting “out-of-normal” events such as broken pallets or crushed cases.

The sum of all data collected within this process will be digitally stored securely in a retrievable manner.

3. Fields of Search

62/132 Refrigeration/Automatic control; 73/156 Measuring and testing/Statistical record verifying; 116/216 signals and indicators/Temperature responsive or compensating means; 136/292 Batteries: thermoelectric and photoelectric/Space-satellite; 136/293 Batteries: thermoelectric and photoelectric/Circuits; 177/136 Weighing scales/Vehicle; 219/608 Electric heating/With electrical control (e.g., speed, temperature, gauging thickness, etc.); 219/386 Electric heating/Portable or mobile; so 257/48 Active solid-state devices (e.g., transistors, solid-state diodes)/Test or calibration structure; 320/153 Electricity: battery or capacitor charging or discharging/Temperature compensation; 346/42 Recorders/Gate, door, or turnstile control member; 346/33TP Recorders/Temperature or pressure; 367/13 Communications, electrical: acoustic wave systems and devices/Testing, monitoring, or calibrating; 374/121 Thermal measuring and testing/Thermally emitted radiation; 455/130 Telecommunications/Receiver or analog modulated signal frequency converter; 700/93 Data processing: generic control systems or specific applications/By another sensor; 700/99 Data processing: generic control systems or specific applications/Temperature; 700/130 Data processing: generic control systems or specific applications/Temperature measuring system; 701/29.3 Data processing: vehicles, navigation, and relative location/For multiple vehicles (e.g. fleet, etc.); 701/29.6 Data processing: vehicles, navigation, and relative location/Vehicle or device identification; 702/85 Data processing: measuring, calibrating, or testing/Calibration or correction system; 702/104 Data processing: measuring, calibrating, or testing/Sensor or transducer; 702/107 Data processing: measuring, calibrating, or testing/Circuit tuning (e.g., potentiometer, amplifier); 702/188 Data processing: measuring, calibrating, or testing/Remote supervisory monitoring; 705/62 Data processing: financial, business practice, management, or cost/price determination/Having printing detail (e.g., verification of mark); 705/14.25 Data processing: financial, business practice, management, or cost/price determination/Based on user history; 705/14.64 Data processing: financial, business practice, management, or cost/price determination/Wireless device; 705/26.8 Data processing: financial, business practice, management, or cost/price determination/List (e.g., purchase order, etc.) compilation or processing; 705/26.81 Data processing: financial, business practice, management, or cost/price determination/Processing of requisition or purchase order; 705/41 Data processing: financial, business practice, management, or cost/price determination/Having programming of a portable memory device (e.g., IC card, “electronic purse”); 705/332 Data processing: financial, business practice, management, or cost/price determination/Special goods or handling procedure; 705/333 Data processing: financial, business practice, management, or so cost/price determination/Tracking; 705/334 Data processing: financial, business practice, management, or cost/price determination/Choice of carrier; 705/336 Data processing: financial, business practice, management, or cost/price determination/Relationship between shipper or supplier and a carrier; 705/337 Data processing: financial, business practice, management, or cost/price determination/Carrier internal procedure; 705/338 Data processing: financial, business practice, management, or cost/price determination/Routing method; 705/339 Data processing: financial, business practice, management, or cost/price determination/Central recipient pick-up; 705/342 Data processing: financial, business practice, management, or cost/price determination/Business documentation.

4. Information Disclosure Statement: Process for Monitoring Items that are in Storage or in Transit by Robert Stetson Gorham

Pursuant to the guidelines for Information Disclosure Statements set forth in 37 C.F.R. Sections 1.97-1.99 and MPEP Section 609, Applicant submits herewith patents, publications or other information of which is believed to be material to the examination of this application and in respect of which there may be a duty of disclosure in accordance with 37 CFR 1.56. A list of patents is set forth herewith:

### RELEVANT PATENT LISTING

PROVISIONAL 2011 0,040,980 Feb. 17, 2011 File Management Safe Deposit Box Kerr; Duncan Robert ; et al.

U.S. Pat. No. 8,301,517 Oct. 30, 2012 Management of loss reconciliation data Thue, et al.

U.S. Pat. No. 8,220,308 Jul. 17, 2012 Systems and methods for remotely calibrating a gas sensor Bellis, et al.

U.S. Pat. No. 8,162,486 Apr. 24, 2012 Remote set-up and calibration of an interactive system Borger, et al.

U.S. Pat. No. 8,148,843 Apr. 3, 2012 Remote device control and power supply Sechrist; William

U.S. Pat. No. 8,060,410 Nov. 15, 2011 Automated transaction processing system and approach Hahn-Carlson

U.S. Pat. No. 8,006,849 Aug. 30, 2011 Processing apparatus and method of operation thereof Pickard, et al.

U.S. Pat. No. 7,895,011 Feb. 22, 2011 Method and apparatus for performing remote calibration verification Youssefi, et al.

U.S. Pat. No. 7,865,044 Jan. 4, 2011 Sensing system using optical fiber suited to high temperatures Farhadiroushan, et al.

U.S. Pat. No. 7,764,830 Jul. 27, 2010 Machine learning of document templates for data extraction Wnek; Janusz

U.S. Pat. No. 7,729,824 Jun. 1, 2010 Remote diagnostic system for detecting tampering of vehicle Calibrations Tolkacz; Joseph

U.S. Pat. No. 7,627,499 Dec. 1, 2009 Automated transaction processing system and approach Hahn-Carlson

U.S. Pat. No. 7,561,734 Jul. 14, 2009 Machine learning of document templates for data extraction Wnek; Janusz

U.S. Pat. No. 7,485,861 Feb. 3, 2009 System and method for remote emissions sensing including calculation and calibration techniques compensating for temperature and pressure effects Full; Gary

U.S. Pat. No. 7,215,212 May 8, 2007 Apparatus for monitoring temperature and method for operating same Mahony, et al.

U.S. Pat. No. 7,162,339 Jan. 9, 2007 Automated vehicle calibration and testing system via Telematics Nguyen; Huan

U.S. Pat. No. 7,130,752 Oct. 31, 2006 Measuring instrument remote calibration system and measuring instrument remote calibration method Yoshida, et al.

U.S. Pat. No. 6,704,612 Mar. 9, 2004 Transaction validation system for auditing and method Hahn-Carlson

U.S. Pat. No. 6,654,590 Nov. 25, 2003 Determining a calibration function using at least one remote terminal Boros, et al.

U.S. Pat. No. 6,630,900 Oct. 7, 2003 Process for carrying out a non-contact remote Interrogation Stierlin, et al.

U.S. Pat. No. 6,571,191 May 27, 2003 Method and system for recalibration of an electronic control module York, et al.

U.S. Pat. No. 6,127,679 Oct. 3, 2000 Thermal sensing system having a fast response calibration device Ashley, et al.

U.S. Pat. No. 5,910,896 Jun. 8, 1999 Shipment transaction system and an arrangement thereof Hahn-Carlson

U.S. Pat. No. 5,780,782 Jul. 14, 1998 On-board scale with remote sensor processing O'Dea

U.S. Pat. No. 5,764,694 Jun. 9, 1998 Self-testing and evaluation system Rahamim, et al.

U.S. Pat. No. 5,734,596 Mar. 31, 1998 Self-calibrating and remote programmable signal conditioning amplifier system and method Medelius, et al.

U.S. Pat. No. 5,357,953 Oct. 25, 1994 Measurement device and method of calibration Merrick, et al.

U.S. Pat. No. 5,118,200 Jun. 2, 1992 Method and apparatus for temperature measurements Kirillov, et al.

U.S. Pat. No. 4,476,706 Oct. 16, 1984 Remote calibration system Hadden, et al.

U.S. Pat. No. 4,328,494 May 4, 1982 Digital data link for truck weighing applications Goodall

U.S. Pat. No. 4,092,627 May 30, 1978 Calibration circuit for expendable sonobuoys Murdock, et al.

### SUMMARY OF THE INVENTION

The Internet or World Wide Web can be a gateway for accessing, organizing and controlling information. Herein presented is a process for monitoring items that may be stored and stationary, or may be in-transit and moving. This process can involve devices which detect temperature. Other devices may be used to detect time and location, while others would detect bumps, shocks or an un-expected opening of the container. In each application, the system will make such data available wirelessly to polling devices.

This process is expected to operate at different levels of complexity. One level would feature a standalone monitor which is free-standing, self powered and deemed to be a single purpose one-time use. These devices have a radio or Bluetooth capability which permits the sensors to be interrogated or polled wirelessly. Likewise the same devices may be polled as a storage container is readied for release. These standalone devices may be interrogated in transit or they may be interrogated up upon arrival at a receiving dock.

The second version is a system in which these sensing devices are permanently installed in a storage container or in a shipping enclosure. At the same time a polling device is also included and installed in the same storage container or in the same shipping enclosure. This device is intended to access Internet when possible. This could be through cell phone communication, satellite communication or any time the unit has access to a Wi-Fi connection. In the storage facility application, that may be simply a connection to WiFi within the storage facility. This polling device will upload all relevant data to a remote Transaction File Server.

In a shipping situation, the shipping container being monitored may be stationary, yet during the bulk of the monitoring period it is mobile. The shipment may be on a train, it may be on a ship, or being transported by tractor/trailer truck. This system includes permanently fixed sensors, their communication appurtenances, and a permanently attached polling system. This polling device is intended to access Internet when possible. This could be through cell phone or satellite communication or any time the unit is has access to a Wi-Fi connection. This polling system is expected to store data and post it to the Transaction File Server whenever an Internet connection makes this link possible.

The system envisions that the polling device accesses the system's Transaction File Server via Internet again with through Wi-Fi connection, cell phone, or satellite connection. The Transaction File Server can include separate data files for agencies which may specify conditions under which the substances or materials in storage or under transit must be maintained. The Transaction File Server may include additional regulatory information which impacts handling or shipping.

Once this information is processed and loaded in the Transaction File Server that data is made available through the Internet to the local computer system. Information can thus be made available to the Common Carrier, the Buyer, the Seller, the Producer, and any appropriate Regulatory Agency. By processing and storing transit or storage data externally, this system can provide an external, “Honest Broker” perspective.

Typically, the process begins when a purchase order is created by a buyer or consignee. If the transaction requires temperature monitoring the buyer is expected to notify the Tracking Host. The Tracking Host will create a Transaction Identification Code. That code will point to a specific folder on a Web Server. Data which may be posted to the folder would be for the exclusive use of parties involved with this transaction. Those parties may be the Seller (consignor), the Buyer (consignee), the Common Carrier. It may also involve a potential retail client to whom the buyer intends to sell the product.

Once the Tracking Host has created the Transaction Identification Code and established a secure data folder, it will forward that Transaction Identification Code in digital form to include a Quick Response QR code. This QR code may be used as part of the Consignee's purchase order.

The Seller in this transaction will produce a Bill Of Lading at the point at which the products would begin transit. That Bill Of Lading would include required temperature monitoring, temperature limits and the Transaction Identification Code or QR code. At the same time, the Tracking Host will have created a new secure web folder into which all authorized parties may upload documents. The Common Carrier and the Consignee may upload the photographic copies of the signed Bill Of Lading with signatures of the driver, the seller's agent releasing for transit the described goods. The Tracking Host will monitor and store data throughout the shipment. That data will be delivered to the Transaction File Server where it will be date and time stamped. The Transaction File Server will make that data available to the Consignee's local computer system.

This system can provide the buyer or the seller information about the shipment, potentially including: time of departure, in-transit temperature ranges, and the amount of time that the shipment was maintained outside required temperature levels. Information may also include motion/acceleration data which may correlate to driving incidents or mishaps. It could also include geo-fencing data. It may include door-open or door-shut conditions, when or where the shipment may have stopped and where it may have been opened prior to the goods being received at the buyer's facilities.

Shipment data can be made available to the parties before the shipment arrives at the buyer's receiving dock. It might contain information that could suggest the shipment should be closely inspected because that shipment may have been maintained outside required temperature ranges.

The second part of this system focuses on the reliability of the temperature sensors. The single-use temperature sensors will be shipped with factory calibration. Fixed-in-place sensors cannot be easily calibrated, however this invention proposes a method for Non-Contact calibration. Four separate components are brought together to determine the validity of fixed-in-place temperature sensors:
1. The system examines power supply integrity.
2. The system examines historic individual temperature sensor records.
3. The system examines historic records of the associated array of fixed temperature records.
4. If the Calibration Server detects that certain sensors may be drifting it will schedule a direct thermal scan of the surface of these prime temperature sensors during a subsequent up-load and “Pairing” for a new Transaction.

### BRIEF DESCRIPTION OF THE DRAWINGS

FIG. 1 is a description of parties to Documents of Title as described in the Uniform Commercial Code and 4 data file types which can impact materials that are in storage or in transit;

FIG. 2 is a diagram of a typical integrated temperature sensor and communication device;

FIG. 3 shows an array of three Temperature Monitor devices being wirelessly polled,

FIG. 4 shows a Temperature Monitor with an integrated Near Field Communications (NFC) circuit;

FIG. 5 shows the same Temperature Monitor's surface only;

FIG. 6 is a cutaway drawing set of a Temperature Monitor;

FIG. 7 describes the Handheld Pairing device with three drawings: side view, bottom side and topside;

FIG. 8 shows a Temperature Monitor next to a Handheld Pairing Device;

FIG. 9 depicts a Handheld Pairing Device plugged into a Temperature Monitor;

FIG. 10 is a set of drawings that depict the locations and interaction among the pairing coils, the aligning sockets and the thermal contact between the Monitor's Temperature sensor and the non-Contact calibration sensor;

FIG. 11 is a set of drawings which display the interaction between the Polling Device and the Hand held Pairing device;

FIG. 12 is a Temperature Monitoring flow chart;

FIG. 13 System flow chart including calibration, activation and data storage.

### DESCRIPTION OF THE PREFERRED EMBODIMENT OF THE INVENTION

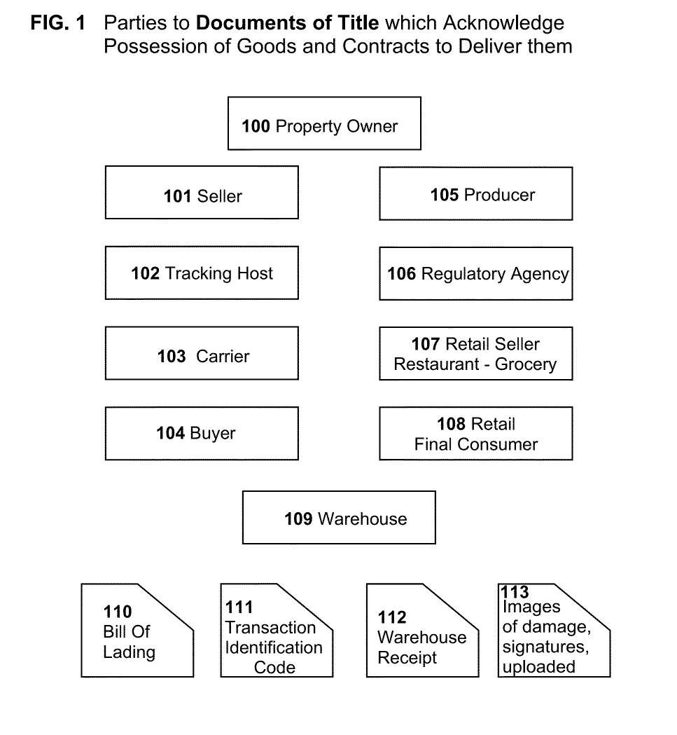

FIG. 1 is a listing of key parties to Documents of Title, as outlined in the Uniform Commercial Code or which may be key agents in the process herein described: Property Owner 100, Seller 101, Tracking Host 102, Common Carrier 103, Buyer 104, Producer 105, Regulatory Agency 106, Retail Seller Restaurant—Grocery 107, Warehouse 109, Bill Of Lading 110, Transaction Identification Code 111, Warehouse Receipt 112, and Photos of Signatures, Damage, etc. 113.

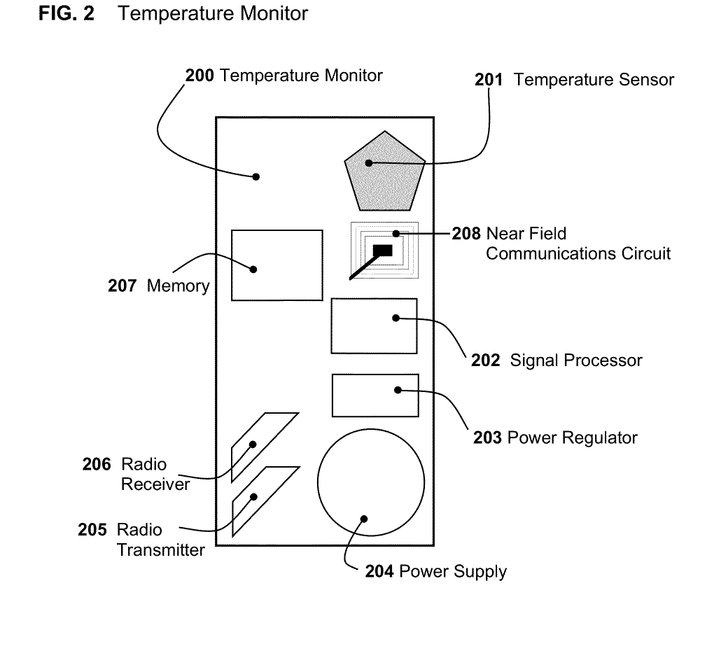

FIG. 2 is a diagram of the Temperature Monitor Circuit Board. The monitor circuit board includes a Thermal Sensor 201, Sensor Signal Processing 202, a Power Regulator 203, a Power Supply 204, a Radio Transmitter 205, a Radio Receiver 206, an on-board Memory 207 and a near Field Communications Circuit NFC 208. The current application of this invention uses a specific Bluetooth® radio transmitter/receiver combination. This Bluetooth® device has a unique 128 bit “Universally Unique Identifier (UUID)” which can uniquely identify each Stand Alone Temperature Monitor 200. The Stand Alone Temperature Monitor is expected to be placed in a sealed storage enclosure or shipping enclosure where it will record temperature and time data. This data will be stored in its onboard memory and transmitted to appropriate polling devices which have been securely “Paired”. The NFC coil permits Bluetooth “Tap to Pair” protocol.

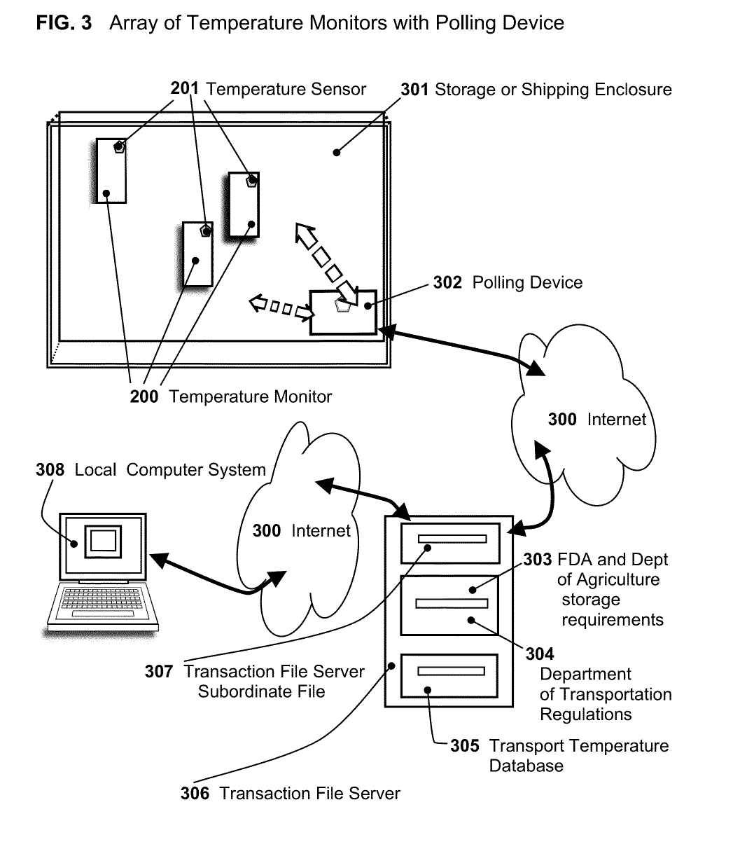

FIG. 3 depicts an Array of Temperature Monitors 200, each of which includes a Temperature Sensor 201. These units would be placed inside a Storage or Shipping Enclosure 301. Typically a storage container or shipping enclosure will contain a set of multiple temperature sensors. These may be deployed at different locations with in the container. The idea would be to detect and monitor different temperature strata and zones throughout that that enclosure.

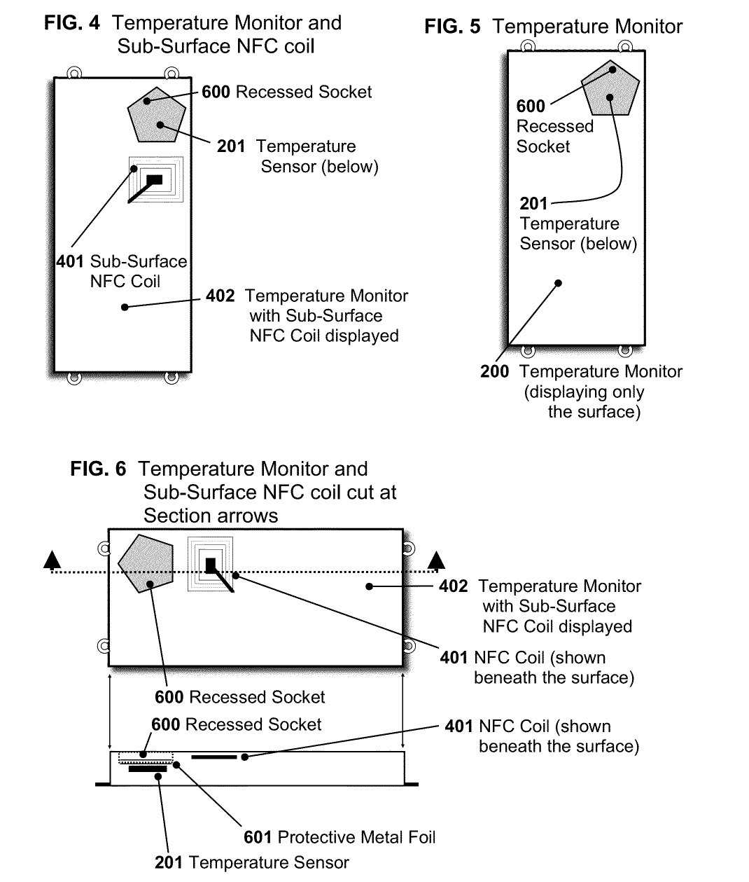

FIG. 4 describes a Temperature Monitor 402 with its Recessed Socket 600. The unit has an embedded Near Field Communication Coil 401 which is actually below then surface of the monitor.

FIG. 5 shows the same Fixed-in-Place temperature Monitor with its Recessed Socket 600 and its underlying Temperature Sensor 201 at the base of the socket.

FIG. 6 shows a transverse section of a Temperature Monitor with its embedded NFC Coil 401 just below the surface and the Recessed Socket 600. The cross section depicts the unit's Temperature Sensor 201 just below the Recessed Socket 600. Between the temperature sensor and the Recessed socket is a Protective Metal Foil 601. This metal protects the temperature sensor and its surrounding circuitry. It is also thermally bonded to the Temperature Sensor 201. The metal has been selected form its good high heat transfer capabilities as well as having a high rate of emissivity, in the range of 0.85 to 0.95.

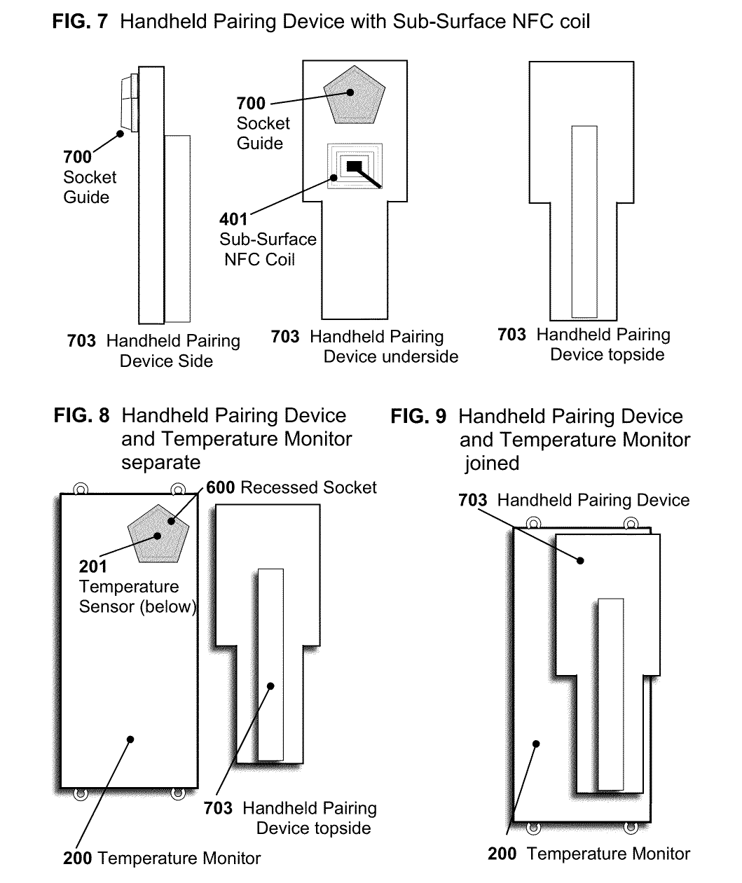

FIG. 7 Shows a Handheld Pairing Device in three views, from its Side 701, from the Underside 702, and from the Topside 703. The drawing depicts a Sub-Surface NFC Coil 401 near the surface of the Underside of the Handheld Pairing Device. It also shows a tapered Socket Guide 700.

FIG. 8 Shows the Temperature Monitor 200 with its Recessed Socket 600. Beneath the Recessed socket lies the Temperature Sensor 201. The Handheld Pairing Device 703 is lying beside to offer scale.

FIG. 9 Shows the Handheld Pairing Device 703 mounted on the Temperature Monitor 200. The Socket Guide 700 is placed inside the Socket 600.

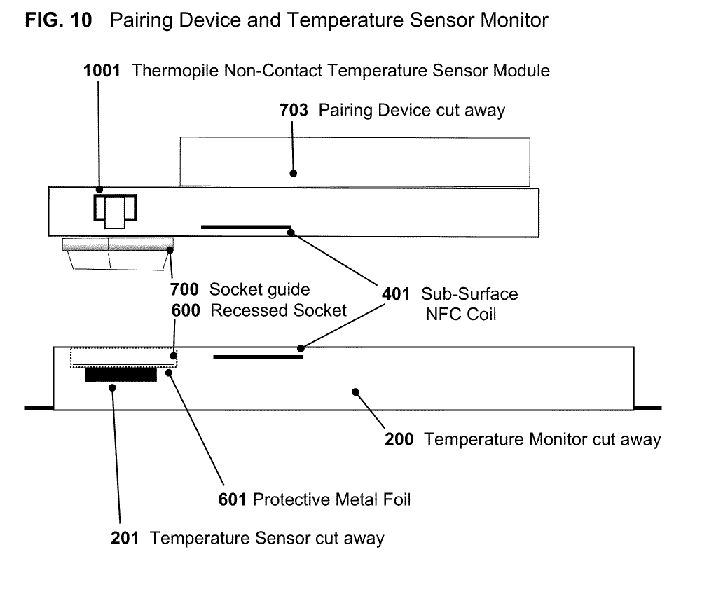

FIG. 10 Shows the Handheld Pairing Device 703 cut away to reveal a Thermopile Non-Contact Temperature Sensor Module 1001. Also shown is the Socket Guide 700 and a Sub-Surface NFC Coil 401. The drawing also shows the Temperature Monitor 200 which has been cut-away. This includes a Temperature Sensor 201 which is thermally bonded to a Protective Metal Foil 601. These sit beneath the Recessed Socket 600. This arrangement allows a precise placement of the two NFC could to permit a precise “Pairing” and exchange of data to start a monitoring session.

This arrangement also brings the Thermopile Temperature Sensor 1001 into close proximity to the Protective Metal Foil 601. The interaction between the Socket Guide 701 and the Socket 600 block much of the spectral interference. The foil is selected because of its known heat transfer and emissivity properties. This allows the Thermopile 1001 to measure the temperature of the Metal Foil 601 at the same time the temperature monitor is measuring the same piece of metal. The measurements can be recorded and the Fixed-in-Place Temperature Monitor may be adjusted or scheduled for replacement. None the less this single step can pair the Bluetooth devices while it calibrates the Fixed in-Place Temperature Monitors.

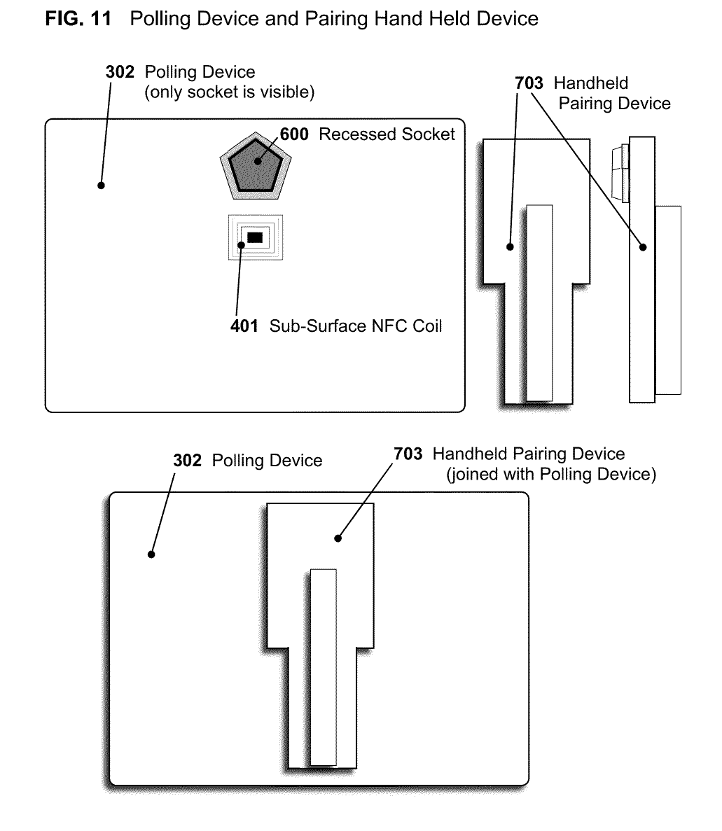

FIG. 11 This diagram shows several views of a Fixed-in-Place Polling Device 302. Like the Fixed-in-Place Temperature Monitors, it also has a Recessed Socket 600. Unlike the Temperature Monitors, the Polling Device does not have a temperature sensor. It does, however have an embedded, Sub-Surface NFC Coil 401. This device's primary responsibility is to periodically poll each of the sensors that have been associated with this particular trip/transaction. It normally should be able to communicate with its assigned Bluetooth devices. It can sync up with its array of sensors using the NFC capabilities presented with the Hand held Pairing device. The Polling Device is expected to record any Geo-Data or ergonomic data the array encounters. It is also responsible for accessing the Transaction File Server 306 as often as the client may specify, through any means the Client may request—that could be WiFi, Cell Tower or satellite.

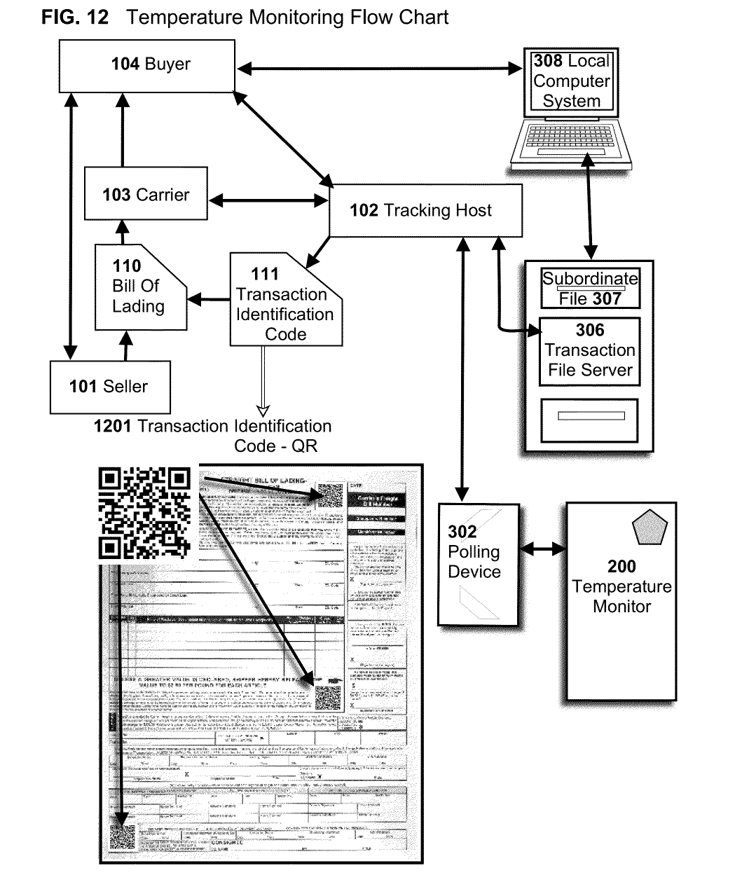

FIG. 12 Is a Flow Chart that details the relationship that may exist among a Buyer 104, a Seller 101, a Carrier 103 and the object of this invention, the Tracking Host 102. The Buyer 104 is responsible for notifying the Tracking Host 102 that a monitored transaction has begun. The Tracking Host will establish a new Subordinate File 307 on the Transaction File Server 306. The Tracking Host will create a Transaction Identification Code 111 and a Transaction Identification Code—QR 1201. This is a 3 Dimensional Quick Response Code which identifies the precise server location for this transaction that has just commenced. These three-dimensional symbols can be read by Smart Phones or other such appliances.

The Tracking host furnishes the Transaction Identification Code—QR 1201 to the Seller 101 for use with the Bill Of Lading 110. The Transaction Identification Code QR symbol will be embedded or printed with in the Bill Of Lading at potentially several sites close to areas in which signatures are required. The proximity of a QR code to signature sites makes it possible to quickly identify the transaction and signatures authorizing delivery or receipt of goods. Information thus obtained will be furnished, along with polled temperature data, processed and stored at the Transaction File Server 503 and made available to the Local Computer system 308 and to other authorized recipients.

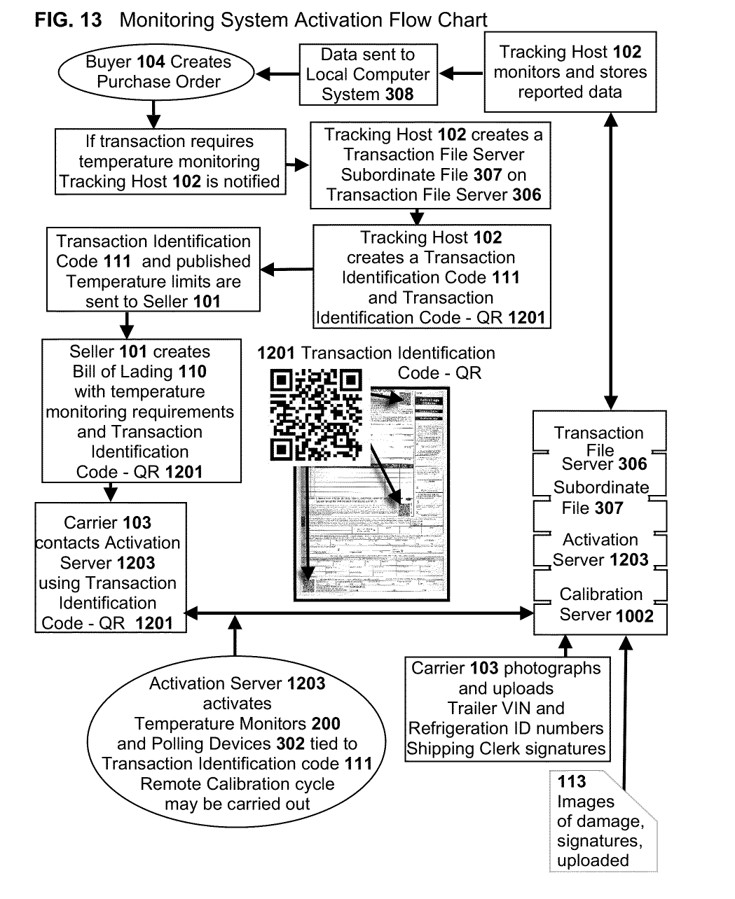

FIG. 13 Is a Flow Chart which goes into greater detail about elements found on the Transaction File Server 306. As in the previous discussion, the Buyer 104 initiates the process, alerting the Tracking Host 102 that a Monitored transaction was needed. The Tracking Host creates a Subordinate File 307 on the Transaction File Server 306. The Tracking Host also creates the Transaction Identification Code—QR 1201. The QR Code and recommended temperature requirements—normally furnished by the Buyer, are furnished to the Seller 101.

The Carrier 103 picks up the Bill Of Lading 110, receives the Transaction Identification Code 111 and contacts the Tracking Host's Activation Server 1203. The Carrier will furnish his equipment identification numbers and the known array of sensors in that particular trailer. If this Carrier or his Equipment had not been activated earlier, his equipment must be installed, calibrated and certified. The Activation Server 1203 manages the activation process

If the tracking host determines a calibration is necessary, the tracking host will run the calibration of the permanently installed temperature sensors.

1. A method of establishing a secure Transaction-Based data structure with a unique Transaction Identification Code, consisting of a two dimensional graphic code that can be printed in multiple locations within Bills Of Lading, on container labels or within warehouse forms and which may appear adjacent to signature blocks, which when signed and date-stamp-photographed and up-loaded to the specified secure server, can substantiate the time sequence and parties involved during the movement or transfer of stored goods.

2. A method of monitoring temperature conditions during the storage or transport of goods, using fixed-in-place Temperature Sensing Devices which can store time and temperature information and retain that information until they are polled wirelessly by a fixed-i-place Polling Device which can analyze such polled data, and forward the data wirelessly through satellite, cell tower or WiFi networks to a secure data storage center.

3. A method of using the same devices of claim 2 to append geographic information harvested during the transmission of temperature data via satellite, cell tower or WiFi network access for deposit in the secure data storage center.

4. A method of tying all temperature data to the exclusive IP, or wireless Bluetooth MAC address of each sensor and using that data to determine if a particular temperature sensor is tracking within an expected range or Normal Distribution of temperatures, failing which, that sensor will be identified for on-site re-calibration or replacement.

5. A method employing the same statistical strategies described in claims 4. to track the performance of all the fixed-mounted Temperature Sensor Devices as an array of multiple temperature sensors and to re-calibrate or replace the entire array of Temperature Sensor Devices.

6. A method of Near Field Communication NFC “pairing” in which the fixed-in-place Bluetooth Temperature Sensor Devices are configured with female “recessed sockets” and the fixed-in-place Bluetooth Polling Device is also fitted with a female “recessed socket” and these devices are mated to a Handheld Bluetooth Pairing Device with a male “Socket guide” and thereby precisely aligning the Near Field Communication field circuits, initiating the “Tap to Pair” protocols and exchanging necessary to initiate a new monitoring Transaction.

7. A method of placing the actual temperature sensor which supports the Fixed-in-Place Temperature Sensor Device in direct thermal contact with a protective metal foil with known emissivity and heat transfer characteristics and to place the sensor and protective foil cover at the base of the Temperature Sensor's Alignment “Socket”, and to install a Thermopile Non-Contact Temperature Sensing module in the Handheld Bluetooth Pairing Device, allowing the Non-Contact Temperature Sensor to precisely measure the temperature of the same Metallic foil which is thermally bonded to the actual sensor driving the fix-mounted Temperature Sensor Device, effectively creating a calibration sequence between the two devices.

8. A method of locating the equipment cited in claim 7 to simultaneously “Tap-to-Pair” Bluetooth devices, and record the calibration process for recording in the Transaction Server's Transport Temperature Database actual temperature sensors, tying each calibration record to a specific MAC address.
